(19) United States
(12) Patent Application Publication
(10) Pub. No.: US 2019/0253738 A1
(43) Pub. Date: Aug. 15, 2019

(54) METHOD FOR PROCESSING ENCODED DATA, METHOD FOR RECEIVING ENCODED DATA, DEVICES, AND ASSOCIATED COMPUTER PROGRAMS

(71) Applicants: B<>COM, Cesson Sevigne (FR); ORANGE, Paris (FR)

(72) Inventor: Patrice Houze, Rennes (FR)

(21) Appl. No.: 15/777,030

(22) PCT Filed: Nov. 18, 2016
(86) PCT No.: PCT/FR2016/053009

§ 371 Date: May 17, 2018

(30) Foreign Application Priority Data
Nov. 20, 2015 (FR) 1561204

(51) Int. Cl. H04N 21/235; H04L 29/06

(52) U.S. Cl. CPC H04N 21/2353; H04L 65/4069; H04L 65/608; H04L 65/607

(57) ABSTRACT

A method for processing encoded data representative of a sequence of digital frames for transmission to client equipment by a client via a communication network. The method includes the following steps, implemented following encoding of a current frame of the sequence: obtaining encoded data representative of the current frame; extracting at least one information representative of an encoding structure of the current frame; updating a transport container by inserting encoded data representative of the current frame into a predetermined location; updating a metadata container, by inserting the at least one information of encoding structure and information representative of the location of the encoded data in the transport container; and transmitting to the client equipment the second container. Upon receipt of a request from the client equipment, including a information representative of the location of the data, transmitting the encoded data of the transport container corresponding to the location.

### 1. CROSS-REFERENCE TO RELATED APPLICATIONS

This Application is a Section 371 National Stage Application of International Application No. PCT/FR2016/053009, filed Nov. 18, 2016, the content of which is incorporated herein by reference in its entirety, and published as WO 2017/085421 on May 26, 2017, not in English.

### 2. FIELD OF THE INVENTION

The field of the invention is that of transmitting and receiving encoded data representative of audiovisual content to one or more clients via a communications network.

The invention may in particular, but not exclusively, apply to adaptive delivery audio-visual content real time to one or more clients.

### 3. DESCRIPTION OF THE PRIOR ART

We know a video content transmission technique, called “http adaptive streaming” consisting in storing server-side, in the form of time segments, several encoded versions of the same video content, corresponding to different quality levels. A client who wishes to receive content, first requires a description file (“MPD” or “manifest”) of the server-side available streams and commands the server to deliver the quality-level segment appropriate to the network transmission conditions available. The version can be changed over time depending on the evolution of these conditions. This technique is described in particular in the article entitled «Dynamic Adaptive Streaming over http (DASH)—Standards and Design Principles», by Thomas Stockhammer, published in the Proceedings of the «ACM Conference on Multimedia Systems, in February 2011, pages 133-144.

### 4. DISADVANTAGES OF THE PRIOR ART

A first drawback of this technique lies in the large size of the segments available to the server, which corresponds in the case of a video sequence, to a duration ranging between 3 and 10 seconds. When the network conditions are not optimal, its transmission may experience a delay or latency that is not compatible with real-time constraints.

A second drawback of this technique is that the data of a segment, be it the description information or the encoded data, are only made available to the client once whole encoding of the segment has been completed, which generates another form of latency that is not compatible either with real-time constraints.

This solution is not suitable for live delivery of audiovisual content.

### 5. SUMMARY OF THE INVENTION

An exemplary aspect of the present invention relates to a method for processing encoded data representative of a sequence of digital frames, for transmission to a client equipment via a communication network in a first container, so-called transport container, for storing at least the encoded data of the frames of the sequence, characterised in that it comprises the following steps, implemented following the encoding of a frame of said sequence, so-called current frame:
obtaining encoded data representative of the current frame;
extracting at least one information representative of an encoding structure of the current frame;
updating the first container by inserting encoded data representative of the current frame into a predetermined location;
updating a second container, so-called metadata container, by inserting said at least one piece of information of an encoding structure and one piece of information representative of the location of the encoded data in the transport container; and
transmitting to the client equipment of the second container;
upon receipt of a request from the client equipment, comprising at least one piece of information representative of the location of the data, transmitting the encoded data of the transport container corresponding to said location.

With the invention, metadata representative of a structure of the current frame are extracted from the encoded data as and when it is obtained by the server that builds a container for transporting the metadata and the data encoded on the fly. This metadata and the encoded data location information of the current frame in this first container are inserted into a second container, so-called metadata container. This second container is transmitted to the client in its intermediate state, in push mode or pull mode. From the information it contains, the client equipment decides which encoded data to request for the current frame.

The transmission of the metadata inserted into the metadata container and of the encoded data inserted into the transport container can also be done in “push” or in “pull” mode.

With the invention, the client equipment first receives the metadata relating to the current segment, then, upon request, the encoded data of this segment.

Thus, the invention is based on a completely new and inventive approach to the delivery of audio-visual content which consists in putting encoded data and metadata associated with this encoded data at the disposal of a client equipment during the construction of the containers intended for transporting them from the server equipment to this client equipment, while leaving the possibility to the client equipment to decide whether it wishes to request the encoded data of the current segment.

According to an advantageous characteristic of the invention, the method comprises a preliminary step of creating the first container, comprising a reservation of a recording space of the encoded data and the encoded data of the current frame are recorded in the location reserved for it as a result of the encoded data previously processed.

One advantage is that the location information of previously encoded frames in the container does not change as it is being constructed.

According to another aspect of the invention, the method comprises a preliminary step of creating the first container, comprising a reservation of a global storage space for the group of frames and the encoded data of the current frame are inserted before the encoded data of previously processed frames.

One advantage is that the container ultimately has exactly the size of the data it contains. The memory space is optimised as well as the transmission resources.

According to yet another aspect of the invention, the encoded data representative of the current frame are obtained for at least two levels of representation, said at least one encoding structure information comprises information relating to the level of representation, the encoded data representative of the current frame are inserted in a sub-container of the first container according to the level of representation and, the request received from the client equipment further comprising encoding structure information relating to the level of representation chosen by the client equipment, the step of transmitting the encoded data comprises transmitting the encoded data of the corresponding sub container to said level of representation.

According to yet another aspect of the invention, the method further comprises a step of segmenting the encoded data obtained according to whether the current frame is part of a segment of the frame sequence, a segment comprising a plurality of consecutive frames and in that the encoded data are inserted into a sub-container of the first container associated with said segment.

The method that has just been described in its different embodiments is advantageously implemented by an device for processing encoded data representative of a sequence of digital frames, for transmission to a client equipment via a communication network in a first container, said transport container, for storing at least the encoded data of the frames of the sequence.

Such a device is particular in that it comprises the following units, able to be implemented following the encoding of a frame of said sequence, so-called current frame:
obtaining encoded data representative of the current frame;
extracting at least one information representative of an encoding structure of the current frame;
updating the first container by inserting encoded data representative of the current frame into a predetermined location;
updating a second container, so-called metadata container, by inserting said at least one information of an encoding structure and information representative of the location of the encoded data in the transport container;
transmitting the second container to the client equipment;
upon receipt of a request from the client equipment, comprising at least one piece of information representative of the location of the data, transmitting the encoded data of the transport container corresponding to said location.

Correlatively, the invention also relates to a method for receiving encoded data representative of a sequence of digital frames via a communication network.

Such a method is particular in that it comprises the following steps, implemented for at least one frame of the sequence, so-called current frame:
obtaining a second container, so-called metadata container, by inserting said at least one information of an encoding structure and information representative of the location of the encoded data in a first transport container;
deciding to request the transmission of encoded data representative of the current frame recorded in the first container according to the information obtained;
in case of a positive decision, issuing a request message for transmitting encoded data representative of said at least one frame, comprising said location information of said encoded data in the first container.

According to one aspect of the invention, said at least one information of an encoding structure of the current frame comprising information relating to a level of representation of the encoded frame among at least two distinct levels, the method comprises a initialization phase during which it requires the encoded data representative of the current frame at the lowest representation level and it estimates parameters representative of transmission conditions of the communication network and for a next frame, it decides to request the encoded data at a chosen representation level based on the estimated parameters.

The method which has just been described in its various embodiments is advantageously implemented by a device for receiving encoded data representative of a digital frame sequence via a communication network. Such a device is particular in that it comprises the following units that can be implemented for at least one frame of the sequence, so-called current frame:
obtaining a second container, so-called metadata container, by inserting said at least one information of an encoding structure of the current frame and a piece of information representative of the location of the encoded data representative of the current frame in a first transport container;
deciding to request the transmission of encoded data representative of the current frame recorded in the first container according to the information obtained;
in case of a positive decision, issuing a request message for transmitting encoded data representative of said at least one frame, comprising said location information of said encoded data in the first container.

The invention also relates to a server equipment capable of communicating with a client equipment via a communication network, characterised in that it comprises a device for transmitting encoded data according to the invention.

The invention also relates to a client equipment capable of communicating with a server equipment via a communication network, characterised in that it comprises a device for receiving encoded data according to the invention.

The invention further relates to a computer program comprising instructions for implementing the steps of a method for processing encoded date as described above, when this program is executed by a processor.

The invention further relates to a computer program comprising instructions for implementing the steps of a method for receiving encoded date as described above, when this program is executed by a processor.

These programs can use any programming language. They can be downloaded from a communication network and/or recorded on a computer-readable medium.

Finally, the invention relates to recording media, readable by a processor, integrated or not integrated with the device for encoding a digital frame and with the device for decoding a digital frame according to the invention, which is optionally removable, thereby storing respectively a computer program implementing a processing method and a computer program implementing a receiving method, as described above.

### 6. LIST OF FIGURES

Other features and advantages of the invention will become evident on reading the following description of one particular embodiment of the invention, given by way of illustrative and non-limiting example only, and with the appended drawings among which:

FIG. 1 illustrates examples of encoding structure information present in a “NALU” unit.

FIG. 2 schematically shows an example of a transport container structure according to the prior art;

FIG. 3 illustrates examples of hierarchical dependencies between frames dependent on a group of frames encoded according to the representation or quality level;

FIG. 4 schematically shows an example of structure of an SSIX indexing file of encoded data in a transport container according to the prior art;

FIG. 5 shows schematically the steps of the method for processing encoded data according to the invention;

FIG. 6 schematically shows a live audio-visual content delivery system according to the invention;

FIG. 7 illustrates the principles of encoding a sequence of tile frames and delivering encoded data representative of tiles at different quality levels from one tile to the next;

FIG. 8 schematically illustrates the difference in weight between intra or I frames and other P or B dependent frames of a group of frames;

FIG. 9 shows schematically the steps of the method for receiving client-encoded data according to the invention;

FIG. 10 illustrates schematically the functionality made possible for a client by the invention to request the encoded data, on a frame by frame basis, according to the resources available;

FIG. 11 schematically illustrates a first exemplary structure of a transport container in which the encoded data are recorded as and when they are being obtained

FIG. 12 schematically illustrates a second exemplary structure of a transport container in which the encoded data are recorded as and when they are being obtained;

FIG. 13 presents in the form of a flow diagram the exchanges between a client and a server during the implementation of an embodiment of the invention;

FIG. 14 shows schematically the hardware structure of a device for processing encoded data according to the invention; and

FIG. 15 shows schematically an example of the hardware structure of a device for receiving encoded data according to the invention.

### 7. DESCRIPTION OF A PARTICULAR EMBODIMENT OF THE INVENTION

The general principle of the invention is based on the extraction and the provision by a metadata server of a video stream (live or on demand) and on the exploitation of these metadata by a client to access these audiovisual metadata frame by frame.

The invention concerns in particular interactive live video applications to benefit from greatly reduced end-to-end delays that use HAS technologies (“HTTP Adaptive Streaming”) as the DASH standard (application of game or vote on TV streams for example). It can also benefit to interactive applications that prefer an enhanced quality for a spatial area of the frame compared to the rest of the frame using DASH technology and a HEVC codec (medical application for example).

In the following description, we consider a video stream or bitstream comprising encoded data representative of a digital frame sequence. This video stream is intended to be transmitted over the networks. It has an organised structure and a precise syntax allows to describe this organisation. The metadata embedded in this structure by the method according to the invention enable the destination decoder to know what type of data sent and the location thereof in the stream, for example where the Intra frames are and/or which tool should be initialised to decode this frame.

A network abstraction layer called NAL was defined by the MPEG standard in particular, to allow the use of the same video syntax in many network environments, this comprises tools such as SPS sequence parameters and PPS frame that offer robustness and flexibility on the decoder side because the temporal and spatial information of the encoded data are clearly described and transmitted with the stream. For example when transmitting a transport container or mp4 file, the first bytes of the video stream contain all these data and allow the decoder to know the structure of the data stream and the decoding tools to implement, so to initialise.

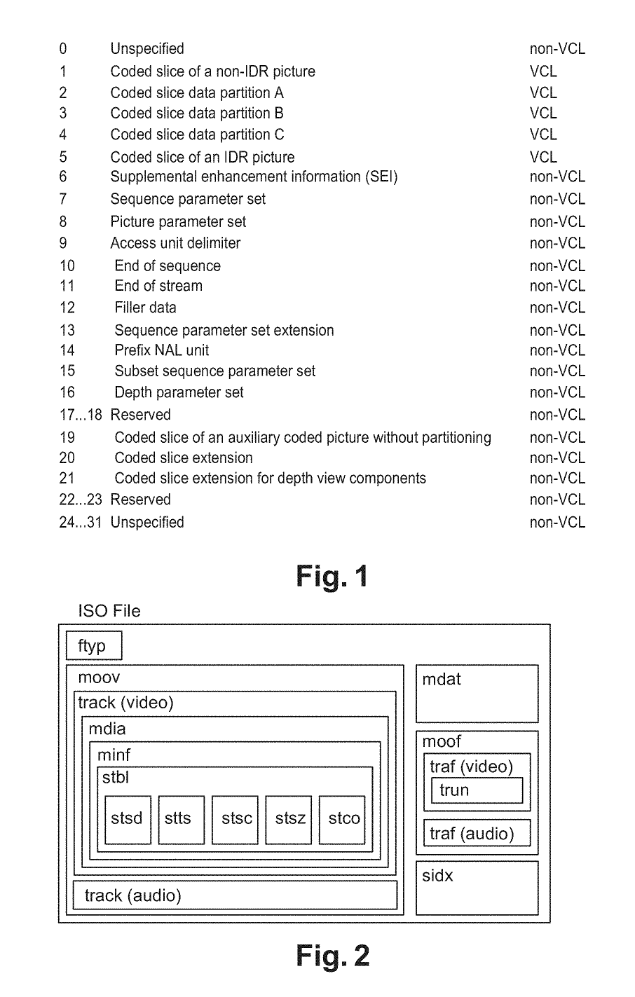

There are “NAL Unit” (NALU) to transport these SPS, PPS, SEI metadata (for “Supplemental Enhancement Information), these NALUs are called “no VCL” (Video Coding Layer) because they do not carry video data. The NALUs intended for the transport of video data are called NALU VCL. There are obviously a lot of other non-VCL information to fully describe the structure of a compressed stream. Examples of information are shown in FIG. 1.

For streams transported in the ISOBMFF format, i.e. on the basis of mp4 files, there is another important information on the NALU external encoding structure (i.e. the data stream itself), it is the SIDX (for “InDeX segment”) which can be used to indicate the location in the stream of Intra-encoded, predicted-encoded or bidirectionally-encoded frames.

An example of a structure or container format for transporting audiovisual streams is shown in FIG. 2. The SIDX information is present in a specific sub-container of the file, it is at the same level as the Moov (sub-container of the description of the media) and the Mdat (sub-container of the video data).

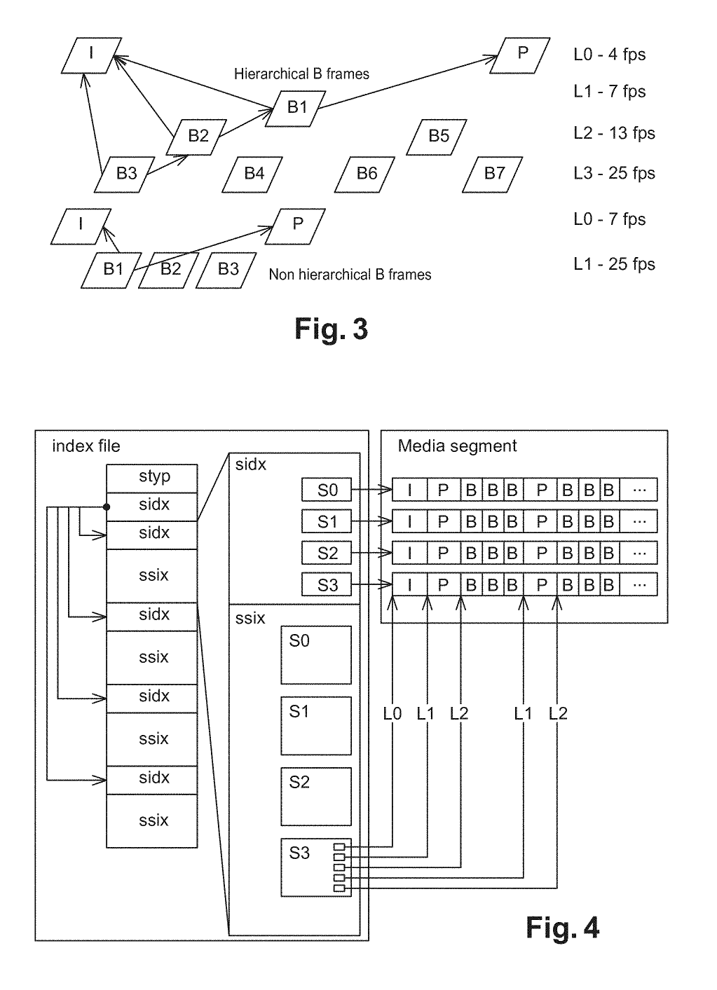

Originally this SIDX information was made available to allow for quick browsing (or “seeking”), such as fast forward or rewind based on the structure of the stream. A more comfortable visual rendering can be based on a frame rate or number of frames per second. FIG. 3 shows the dependencies between frames as well as the frame rates associated with the successive levels L 0 to L 3 of a hierarchical encoding structure. The MP4 file is downloaded and browsing in this file is made possible by said information. We understand that the file must have been previously downloaded (video on demand). Such a mechanism is not suitable for live transmission.

For example, the DASH transport technology which consists in transferring the data in the form of small segments (small files) in succession uses this functionality, it comprises the information in a sub-box called SSIX (“Sub-Segment IndiaX”).

DASH is a so-called adaptive technology that allows to download segments of different quality (resolution, bit rate), each DASH representation will have its SIDX and its corresponding SSIX, the SSIX clearly displays the levels that the DASH client can use to adapt its frame rate. In connection with the Figure, an example of an index file format, as specified for example by ISOBMFF (for “ISO Base Media File Format”) in the paper published in July 2014 and available at the following address www.w3.org/2013/12/byte-stream-format-registry/isobmff-byte-stream-format.html.

This mechanism allows a DASH client that has downloaded a succession of files (segments) each having the frame rate associated with the file, regardless of the representation (bitrate) downloaded, to move in the succession of segments forming the complete file at the correct frame rate (e.g. 7 frames per sec).

The purpose of the invention is to make available to the client all these definitions of syntax and metadata on the fly. In other words, the client receives the structure information at the same time as the data file, “it receives the package containing a shelf to be assembled together with its assembly instructions”.

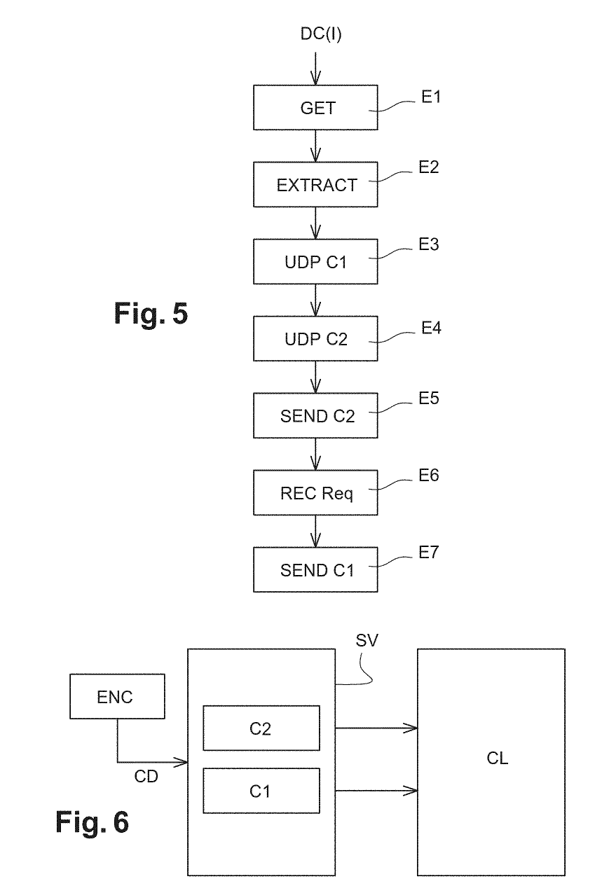

In connection with FIG. 5, the steps of a method for processing encoded data representative of a frame sequence according to an embodiment of the invention are described. This method is for example implemented by a server equipment SV, shown in FIG. 6.

The sequence of frames is encoded by an encoder integrated or not to the server equipment. For example, this encoder produces data encoded according to the specifications of a compression standard such as AVC, HEVC or a future version called “post HEVC”.

In E1, encoded data representative of a current frame of the sequence are obtained. If the encoder is integrated with the server, the encoded data may be raw. If the encoder is not integrated with the server, they are encapsulated in a transport container C0, for example compliant with the MPEG-2 TS or ISO BMFF standard.

In E2, at least one piece of information representative of an encoding structure of the current frame is extracted from the encoded data;

In E3, we update a first container, so-called transport container by inserting encoded data representative of the current frame into a predetermined location. It is assumed that this container has been previously created and is filled as the encoded data and their associated metadata are received from the encoder.

Advantageously, the method according to the invention further comprises a step of segmenting the encoded data, that is to say that the container comprises sub-containers intended to record a predetermined quantity of data, corresponding for example to a certain number of consecutive frames of the frame sequence.

In E4, a second container, said metadata container, is updated by inserting said at least one piece of extracted encoding structure information and one piece of information representative of the location of the encoded data in the transport container.

In E5, the first container is transmitted to the client equipment. It is understood that this container can be transmitted while its construction has not been completed. Advantageously, it is transmitted to the client regularly after an update, in its entirety, or only the information added during the last update.

From this metadata container, the client will extract spatial and temporal structure information from the already available frame(s) and decide which ones ought to be downloaded. It will then request a part of the container C1 according to its decision. In the case where the encoded data stream is segmented, the sub-container C1 corresponding to the segment being filled may not be completed and in this case, only the encoded data representative of the current frame are transmitted to the client. In the same way, the metadata container C2 is transmitted to the client before being definitively built.

A purpose is to allow a DASH client to know the syntax and structure information of the encoded data before downloading the file itself in order to allow making choices a priori and not a posteriori.

According to one embodiment of the invention, a server/client channel is used for transferring these data. This channel is separated from the transmission of conventional data of the adaptive DASH stream, namely the encoded data. The client uses the metadata extracted from the upstream server/encoder side stream and transmitted (in advance) to the client to optimally choose the video data to be downloaded.

In connection with FIG. 6, the step E2 of extracting metadata (PS, SPS, SEI) is performed on the server or encoder side. An encoded video stream available at the output of the ENC encoder or upstream of the server SV is a stream that is formatted to contain all the information needed for decoding. This information is typically enriched in real-time on the encoder side that produces a transport container C0 containing the metadata and the encoded audio and video streams, at one or more levels of quality/bitrate (often called a TS stream called Mezzanine in case of multi-rates) “transportable on the network”. This information to be extracted is present as soon as the stream is encoded and made available to a server (in the “live” case). The extraction operation therefore consists in extracting the relevant information at the place where it is present in the Mezzanine stream.

According to one embodiment of the invention, the provision of the extracted information and its distribution to a client is carried out as follows:
the extracted information is then outsourced from the main stream that contains all the useful data (encoded data and metadata).
The information is formatted, that is, it is organised in a container C2, in the form of a client-readable structure, for example a simple XML structure that contains the information requested by the client (PPS, SPS, SEI, SIDX, . . . ) or a more complex structure, for example for a description file (“Manifest”) Metadata (MMPD for “Media Metadata Presentation Description”, which is synchronised with the MPD DASH description file. This MMPD file provides the continuously updated MMPD information corresponding to the upcoming MPD, but therefore a little in advance and in any event, before the segment is completely built on the server or server/segmenter side. In this way, the client gets the information allowing him to choose the level of quality/bitrate to require for the current segment;
The information can be transmitted to the client in different ways, either simply in client/server pull mode on http. In this case, the client requests the XML or Manifest file whenever it wishes to make a decision in advance. As a variation, either a push/pull mode is used by opening a parallel channel on a TCP socket using a protocol such as “Websocket”, either in push mode using the monitoring system SAP Announcement Multicast, wherein the server supplies a “reserved” multicast (@multicast reserved) to refresh in real time information related to one or more streams.

The provision of syntax and metadata information on the fly can find many applications. Two specific application examples are now described, implementing the DASH technology:
Need to know a priori the spatial organisation of a stream of data encoded according to an HEVC or AVC-type diagram, in a mode according to which the frames of the sequence are partitioned in tiles or slices.

This first customary case relates to a method of adaptation to the bitrate on a tile by tile basis through the overall bandwidth of a client. An HEVC or AVC data stream is built for a distribution in adaptive streaming mode and thus declined in several representations (bitrates). The principle seen from the client is to optimise the available bandwidth and therefore to request different bit rates for each tile according to a more or less complicated algorithm, which can at least privilege the central tiles but which can also be controlled by recognition engines of area of interest (texture, colour, face recognition, etc).

The information on the number of tiles, the fact that they are identical in a sequence is announced in the SPS and PPS type metadata, the inter-tile dependencies are indicated in specific NALU message SEI.

A purpose for the client is to receive the non-VCL NALU without the VCL NALUs which contain the encoded video data (Element Stream ES), without knowing a priori the sizes of these NALUs. According to the invention, a few tens of bytes are required to obtain the entire SPS, PPS and SEI.

A proposed alternative is to extract, format and distribute these server-side metadata. The client requests the information available on the server side whenever he needs (e.g. for each segment, each GoP, possibly each frame), he can even subscribe to one or more bitstreams to obtain metadata corresponding to each representation refreshed permanently, for example in the form of an “SAP announcement” message.

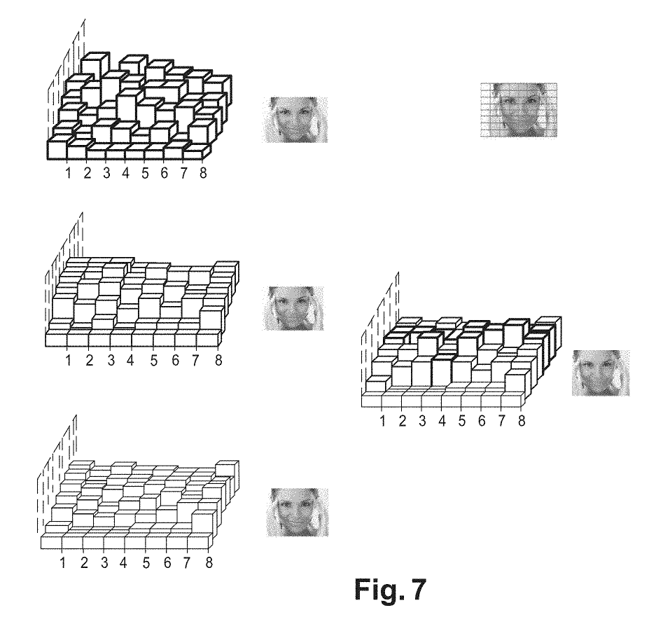

In relation to FIG. 7, the principle of composition of a “tiled” frame adapted to the client rate is illustrated. The adaptation algorithm is made on the client side, which requires knowing the number of tiles, their size, and their dependencies before deciding downloads for a complete GoP.

The extraction of metadata is relatively simple in this case because the non-VCL NALU and VCL NALU information are built on the fly to form a continuous stream, GoP by GoP. It is therefore necessary to parse the data in the tributary, to organise them and to make them available to the client.
Need to know the temporal structure implemented for the encoding of an AVC or HEVC stream

In this customary case, the point is to be able to know a priori the type of frame (for example Inter, Intra or bidirectional), the decoding metadata, the size of the latter and the byte range of each level of representation of a given stream. The object is to obtain this information in advance to be able to decide which representation we wish to download according to the network conditions or time constraints, i.e. frame by frame (knowing that a decision for an intra frame applies to Full GoP, given temporal dependencies).

The cases of applications can be multiple for applications that require to know the semantics of the content: live implementation under time constraint, the applications running on multiple network paths (multipath) for which they will apply different priority rules according to the importance (type of frame) of the video information transported.

This information is obviously present in all file formats (mp4, TS, . . . ) in the form of metadata, a particularity for the ISOBMFF and TS formats, however, is very interesting for adaptive DASH streams (now the standard).

This is the SIDX information defined and standardised for the ISOBMFF format that combines with the contributions of DASH which offers an enrichment with information called SSIX.

This SIDX layout was designed to be used for downloaded files (video on demand) but this specification can advantageously be used for live streams, the only constraint is to remain compliant with the standard. The standard provides this information in the In band segment for ISOBMFF files and rather in an external container for TS files.

The idea is to extract on the fly this SIDX/SSIX information from each available server-side representation, and to make it available to the client for each available frame (i.e. every 40 ms), refreshment is permanent and the information is made available to the client (such as a metadata server synchronised with the MPD of the available segments and the current segment).

Mainly in the case of a DASH content (ISOBMFF or TS), the aim is to allow the client (or proxy) to query information of bytes-range from Intra, Prediction and Bidirectional information in each representation to be able to decide what representation he wants to/can download and on which path if it is Multipath.

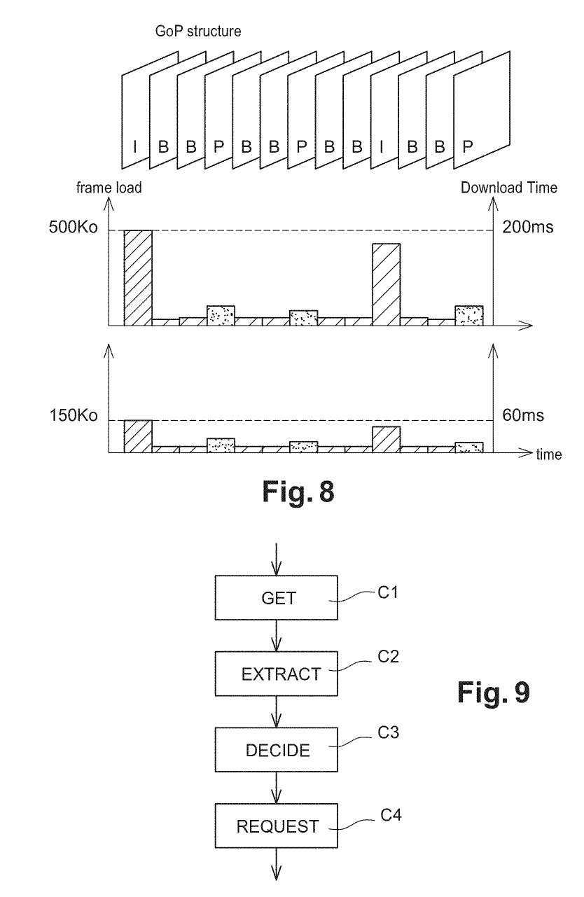

In relation to FIG. 8, the steps of a method for receiving encoded data according to the invention will now be described. This method is for example implemented by a client equipment or by a proxy device located at the cut-off of the path followed by the data streams from the server equipment and upstream of the client equipment in the communication network.

It is assumed that a client equipment has previously requested a MPD description file of the audiovisual content that he wishes to receive. In the case of a live application, this file is not necessarily complete, because the encoding of the frame sequence of the audiovisual content is in progress.

According to the invention, during a step C1, a second container, so-called metadata container is obtained, comprising at least one piece of information of an encoding structure of a current frame and a piece of information representative of the location of the encoded data representative of the current frame in a first transport container.

In C2, it is decided, based on the metadata information obtained, to request the transmission of encoded data representative of the current frame recorded in the first container based on the information obtained.

In case of a positive decision, a request message for transmitting encoded data is issued, representative of said at least one frame intended for the server, comprising said location information of said encoded data in the first container.

In relation with FIG. 9, it can be seen that the I or Intra frames have a much higher weight than the predicted frames of Inter P or bidirectional B types. For these I frames, it is particularly important for the client to have access to structure metadata, in order to adapt its query to the resources available.

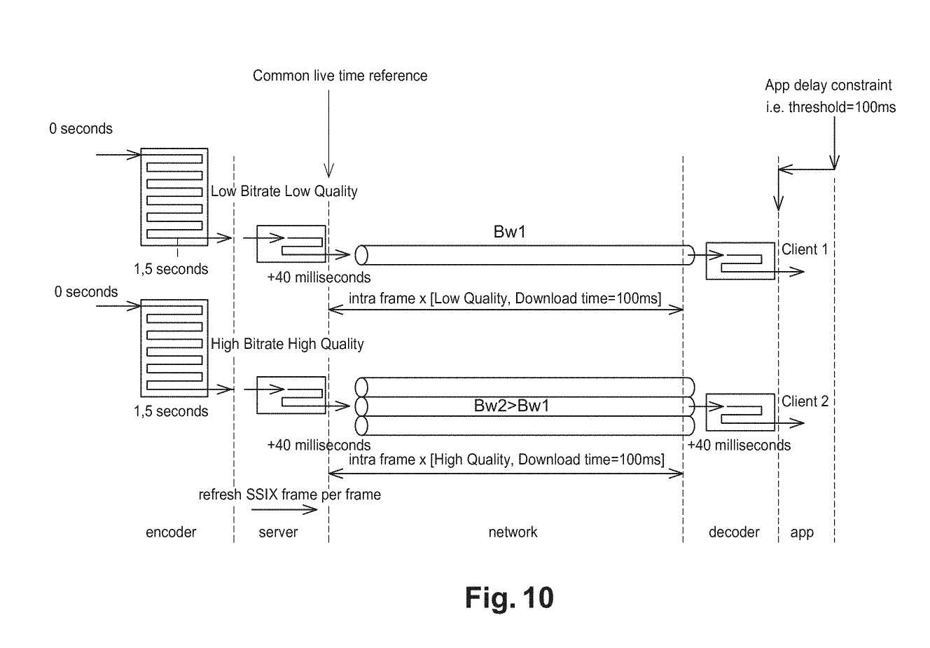

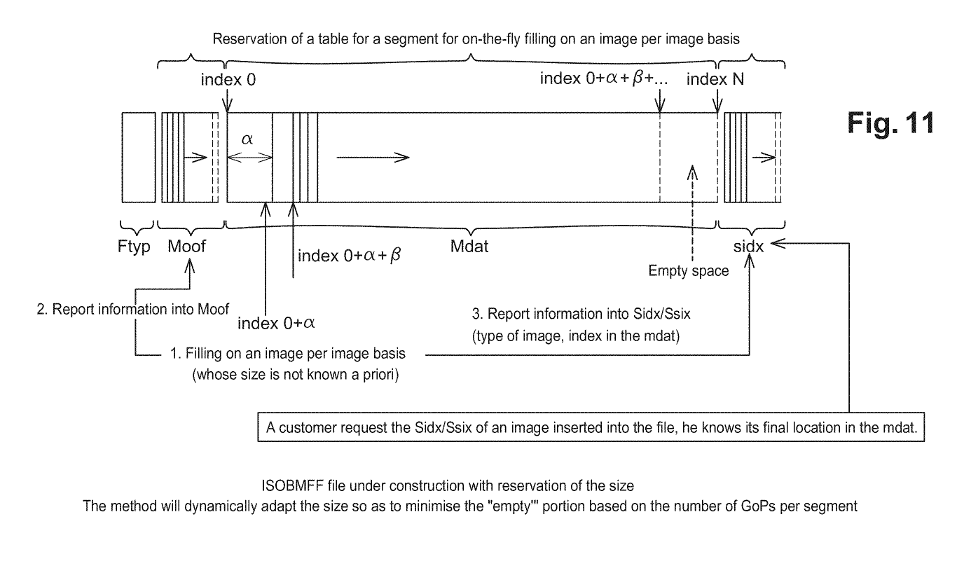

In FIG. 10, there is shown a first client C11 that requires an Intra frame with a low quality level because it has a limited bandwidth BW1 and a second client C12 that requires the same Intra frame with a level of higher quality because its passing band BW2 is higher.

The invention implements on the server side a mechanism for extracting said metadata structure of the video stream during the construction of the segment. The DASH server must be able to extract these metadata, frame by frame, while it is building the segment.

In addition, it is desired that the segment remains compliant with the DASH specifications. Once the segment has been completed, a reservation must therefore be calculated for proper indexation of the final segment. The offset being calculated, the frame by frame information is enriched on the fly that will constitute the final segment. The client can thus regularly request, for example every 40 ms, the SSIX info's of the frames which are presented on the fly in the box, and this for each representation or level of stream/quality encoded on the server side.

The invention also defines a format for these metadata (SSIX of each performance with different levels) which the client needs and a transmission mode (http, web socket).

The client reads the SIX metadata after download of a GoP and decides which representation and byte-range what it will require for the GOP following.

According to a first embodiment of the invention, illustrated by FIG. 10, the complete structure of the segment (MP4) is built without “closing” it in order to extend it according to the actual size of the encoded frames and to fill it as the encoding progresses. The SSIX metadata file describes the encoding structure and thus allows individual access to each frame of a segment. Thus, each time the encoder generates the encoded data representative of a frame of the sequence, it is placed in the “right place” in a Moof+Mdat and the headers of the segment file (Moov) and the SIDX and SSIX indexes are enriched. In this case, only the size of the headers up to the first Moof must be known at the start of a segment.

According to a second embodiment of the invention, illustrated in FIG. 11, one can also build continuously the file by inserting the encoded data of a current frame before the encoded data of a previously processed frame and shifting the boxes already present. In this case, the index associated with the encoded data of the previous frame is modified accordingly.

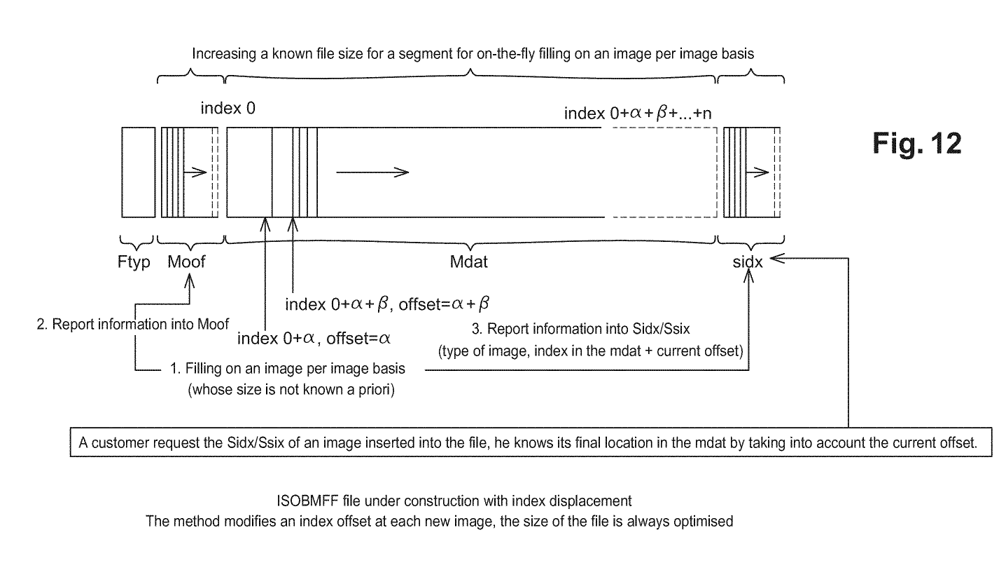

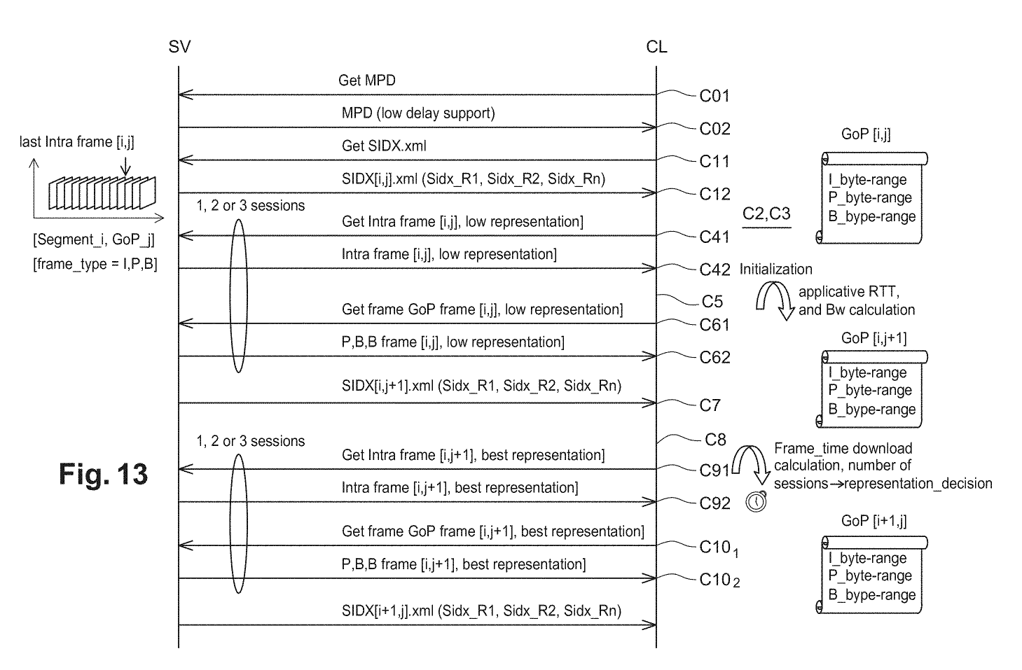

In connection with FIG. 12, we now describe a particular embodiment of the invention, according to which a C1 client wishes to receive a live audiovisual content from an SV server. It is assumed that the SV server implements an adaptive transmission mode, for example according to the DASH protocol. It receives encoded data from an encoder in N different representations, with N non-zero integers, which it cuts into segments. The encoded data corresponding to a segment are encapsulated in a sub-container of a transport container, for example compliant with the ISO BMFF standard, as illustrated by FIG. 4 already described.

During a step C01, the client requires a description file or MPD of the audiovisual content.

It is obtained in C02. In known manner, this file describes the different representations R1 to RN, with N non-zero integers, or quality levels of the encoded content that will be made available to clients by the server.

This file is further assumed to indicate that the server supports a type of “low delay” functionality. This functionality corresponds to that provided by the method of processing audiovisual content according to the invention, which has just been described. This feature allows a server to make frames of the content available to its clients as it receives them from the encoder without waiting for a complete fragment.

In C1, a metadata container is obtained from the server, containing encoded structure information, for example the type of a frame, decoding information such as STC and the PTS and location information, by for example, the start and end indexes SIDX of the encoded data representative of the frames of the sequence already available in the transport container.

For example, the client explicitly requires this metadata container in C11 and receives it in C12. For example, this container is in .xml format conforming to the XML standard (for “Extensible Markup Language”).

As a variation, this metadata container can take the format of a MPD or “Manifest” type data description file. In this case, there should be an extension of the DASH standard specifying the fact of providing the location information of the encoded data and the encoding structure information of a frame of the sequence into an MPD file.

In C2, the client extracts information from this metadata container and decides in C3 if it requests them based on metadata received (size, level of representation).

In C41, it requests from the server the encoded data representative of the most recent intra I frame in its lower quality representation, R1. We assume that it is the i-frame of the frame group GOP j, with i and j non-zero integers. This is an initialization phase during which the client tests the communication resources available with the SV server.

It should be noted that the implementation of this step can be done in different ways. The client can use one or more communication paths to the server and, on each of these paths implement one or more communication sessions, for example according to a TCP type (for “Transmission Communication Protocol”) communication protocol. Advantageously, it can choose to request encoded data fragment by fragment on one or more of the communication paths available.

In C42, the client receives the encoded data representative of the i, j-frame of the representation R1.

In C5, it calculates the Round Trip Time and evaluates the actual bandwidth available on the transmission path(s) with the server.

In C61 it requires the transmission of the other frames of the group of frames GOPj in the same representation R1 as the frame I. It is assumed that they are on I, P for predicted or B for bidirectional dependent frames. As these frames have a weight much lower than that of the frame I, it is conceivable to request them at one time. They are received in C62.

In C7, the client obtains from the server an updated version of the metadata container, for example of type SIDX.xml. Advantageously, the server regularly sends a new version to the client in push mode. Of course, the Pull mode as previously described is also possible.

From this new version of the metadata container, the client extracts in C8 the weights of the next frame I in the different available representations, estimates the time of reception of this new frame I using the network parameters that it evaluated in C5 and decides the best representation to request.

In C91 it therefore requires the following frame I (GOP j+1) in the chosen representation, receives it in C92. In C10 1 it requires GOP dependent frames j+1 in the same representation and it receives them in C102.

Note that if it has several paths to the server, the client may require the dependent frames on a path before having received the frame I on another path completely.

The process steps are then repeated for the next groups of frames in the sequence.

The invention that has just been presented allows on the server side to extract the metadata of a stream under construction (“live” or “on demand”).

It feeds on the fly, frame by frame, the metadata information needed to download the current frame and information related to its spatial and temporal structure (its dependencies).

Advantageously, it provides an “out of band” formatting step of a metadata container, which is refreshed as the server obtains encoded data representative of a new frame of the sequence.
It provides a mechanism to enrich the metadata information to make the native information of a transport container or segmented DASH file (SIDX/SSIX) to be downloaded, consistent and compliant.

Advantageously, the invention provides a client/server request channel for retrieving additional metadata information before downloading encoded data (of the web socket, http type).

On the client side, the invention further provides a specific module (which may be external to a video or integrated DASH client) capable of querying the metadata, particularly the metadata container and the possibility for the client to decide which encoded data it wishes to request (I, P, B frames, representation, tile etc.)

It will be noted that the invention just described, can be implemented using software and/or hardware components. In this context, the terms “module” and “entity” used in this document, can be either a software component or a hardware component or even a set of hardware and/or software, capable of implementing the function(s) outlined for the module or entity concerned.

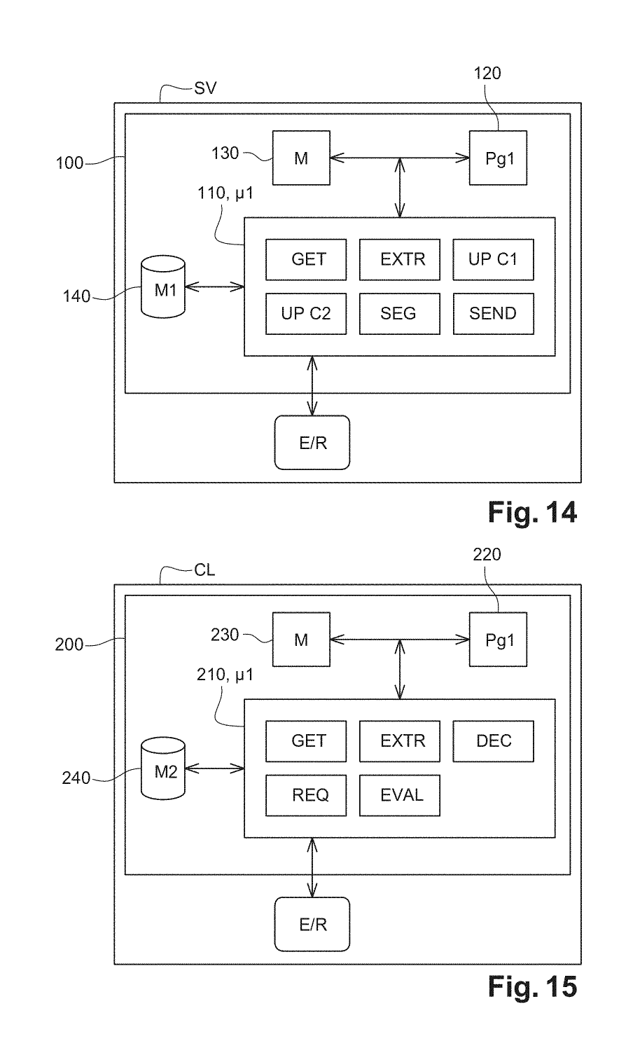

In relation to FIG. 14, we now present an example of simplified structure of a device 100 for processing encoded data according to the invention. The device 200 implements the method for processing encoded data according to the invention which has just been described in connection with FIG. 5.

For example, the device 100 comprises a processing unit 110, equipped with a processor μ1 and driven by a computer program Pg1 120 stored in a memory 130 and implementing the method according to the invention.

At initialisation, the code instructions of the computer program Pg1 120 are for example loaded into a RAM before being executed by the processor of the processing unit 110. The processor of the processing unit 110 implements the steps of the method described above, according to the instructions of the computer program 120.

In this embodiment of the invention, the device 100 comprises at least one GET unit for obtaining encoded data representative of the current frame, an EXT unit for extracting at least one piece of information representative of an encoding structure of the current frame, a UP C1 unit for updating the first container by inserting encoded data representative of the current frame into a predetermined location, a UP C2 unit for updating a second container, so-called metadata container, by inserting said at least one encoding structure information and one information representative of the location of the encoded data in the transport container; and a SEND transmission unit to the client equipment of at least the second container C2.

Advantageously, the device 100 further comprises a SEG unit for segmenting the data encoded into time segments. In this case, the encoded data are inserted in a sub-container of the first container C1 associated with said segment.

The device 100 further comprises a first storage unit M1, for example of the buffer type, of encoded data representative of at least one frame of the sequence.

These units are controlled by the processor μ1 of the processing unit 110.

Advantageously, such a device 100 can be integrated with an SV server equipment, for example according to the DASH standard. The device 100 is then arranged to cooperate at least with a transmitting module in a communication network of the server equipment.

In relation to FIG. 15, we now present an example of simplified structure of a device 200 for processing encoded data according to the invention. The device 200 implements the method for receiving encoded data according to the invention which has just been described in connection with FIG. 8.

For example, the device 200 comprises a processing unit 210, equipped with a processor μ2 and driven by a computer program Pg2 220 stored in a memory 230 and implementing the decoding method according to the invention.

At initialisation, the code instructions of the computer program Pg1 120 are for example loaded into a RAM before being executed by the processor of the processing unit 210. The processor of the processing unit 210 implements the steps of the method described above, according to the instructions of the computer program 220.

In this embodiment of the invention, the device 100 comprises at least one GET unit for obtaining a second container, so-called metadata container, by inserting said at least one encoding structure information of the current frame and a piece of information representative of the location of the encoded data representative of the current frame in a first transport container, an EXT unit for extracting said at least one encoding structure information of the current frame and a piece of information representative of the location of the encoded data representative of the current frame in a first transport container, a DECIDE unit for deciding to request the transmission of encoded data representative of the current frame recorded in the first container according to the information obtained and a SEND unit able to issue, in case of positive decision, a request message for transmitting encoded data representative of said at least one frame, comprising said location information of said encoded data in the first container.

Advantageously, the device 200 further comprises an EST unit for estimating the parameters representative of the communications network transmission conditions.

The device 200 further comprises a first storage unit M2, for example of the buffer type, of encoded data representative of at least one frame of the sequence and metadata information received from the server equipment.

These units are controlled by the processor μ2 of the processing unit 210.

Advantageously, such a device 200 can be integrated with a CL client equipment, for example compliant with the DASH standard. The device 200 is then arranged to cooperate at least with a transmitting module in a communication network of the client equipment.

An exemplary embodiment of the present invention improves the situation discussed above with respect to the prior art. An exemplary embodiment in particular overcomes the shortcomings of the prior art.

More specifically, an exemplary embodiment of the invention proposes a solution that allows a client to access the encoded data as and when they are encoded, with a granularity less than that of a time segment.

It goes without saying that the embodiments which have been described above have been given by way of purely indicative and non-limiting example, and that many modifications can be easily made by those skilled in the art without departing from the scope of the invention.

1. A method for processing encoded data representative of a sequence of digital frames, for transmission to a client equipment via a communication network in a first container, called a transport container, for storing at least the encoded data of the frames of the sequence, wherein the method comprises the following acts performed by a processing device, implemented following encoding of a current frame of said sequence:
obtaining encoded data representative of the current frame;
extracting at least one information representative of an encoding structure of the current frame;
updating the first container by inserting encoded data representative of the current frame into a predetermined location;
updating a second container, so-called metadata container, by inserting said at least one information of encoding structure and information representative of the location of the encoded data in the transport container; and
transmitting the second container to the client equipment;
upon receipt of a request from the client equipment, comprising at least one piece of information representative of the location of the data, transmitting the encoded data of the transport container corresponding to said location.

2. The method for processing encoded data representative of a sequence of digital frames, according to claim 1, comprising a preliminary act of creating the first container, comprising a reservation of a recording space of the encoded data and wherein the encoded data of the current frame are recorded in the location reserved for the encoded data as a result of the encoded data previously processed.

3. The method for processing encoded data representative of a sequence of digital frames, according to claim 1, comprising preliminary step of creating the first container, comprising reserving a global storage space for a group of the frames and wherein the encoded data of the current frame are inserted before the encoded data of previously processed frames.

4. The method for processing encoded data according to claim 1, wherein the encoded data representative of the current frame are obtained for at least two levels of representation, wherein said at least one encoding structure information comprises information relating to said levels of representation, wherein the encoded data representative of the current frame are inserted in a sub-container of the first container according to the level of representation, and wherein the request received from the client equipment further comprises encoding structure information relating to the level of representation chosen by the client equipment, the act of transmitting the encoded data comprising transmitting the encoded data of the corresponding sub container to said level of representation.

5. The method for processing encoded data according to claim 1, further comprising segmenting the encoded data obtained according to whether the current frame is part of a segment of the frame sequence, a segment comprising a plurality of consecutive frames, and wherein the encoded data are inserted into a sub-container of the first container associated with said segment.

6. A device for processing encoded data representative of a sequence of digital frames, for transmission to a client equipment via a communication network in a first container, called a transport container, for storing at least the encoded data of the frames of the sequence, wherein the device comprises:
a processor;
a non-transitory computer-readable medium comprising instructions stored thereon, which when executed by the processor configure the device to perform the following acts, implemented following encoding of a current frame of said sequence:
obtaining encoded data representative of the current frame;
extracting at least one information representative of an encoding structure of the current frame;
updating the first container by inserting encoded data representative of the current frame into a predetermined location;
updating a second container, so-called metadata container, by inserting said at least one information of an encoding structure and information representative of the location of the encoded data in the transport container; and
transmitting the second container to the client equipment;
upon receipt of a request from the client equipment, comprising at least one piece of information representative of the location of the data, transmitting the encoded data of the transport container corresponding to said location.

7. A method for receiving encoded data representative of a sequence of digital frames via a communication network, wherein the method comprises the followings acts, implemented by a receiving device for at least one frame of the sequence, called a current frame:
obtaining a second container, called a metadata container, comprising at least one information of an encoding structure of the current frame and a piece of information representative of the location of the encoded data representative of the current frame in a first transport container;
extracting said at least one information of an encoding structure of the current frame and a piece of information representative of the location of the encoded data representative of the current frame in a first, transport container;
deciding to request the transmission of encoded data representative of the current frame recorded in the first, transport container according to the information obtained; and
in case of a positive decision, issuing a request message for transmitting encoded data representative of said at least one frame, comprising said location information of said encoded data in the first, transport container.

8. The method for receiving encoded data representative of a sequence of digital frames, according to claim 7, wherein said at least one information of an encoding structure of the current frame comprises at least one information relating to a level of representation of the encoded frame among at least two distinct levels, and the method comprises an initialization phase during which the method requires the encoded data representative of the current frame at a lowest representation level and comprises estimating parameters representative of transmission conditions of the communication network and for a next frame, and deciding to request the encoded data at a chosen representation level based on the estimated parameters, the request further comprising a piece of information relating to the level of representation selected.

9. A device for receiving encoded data representative of a sequence of digital frames via a communication network, wherein the device comprises:
a processor;
a non-transitory computer-readable medium comprising instructions stored thereon, which when executed by the processor configure the device to perform the following acts, implemented for at least one frame of the sequence, called a current frame:
obtaining a second container, called a metadata container, comprising at least one information of an encoding structure of the current frame and a piece of information representative of the location of the encoded data representative of the current frame in a first transport container;
extracting said at least one information of an encoding structure of the current frame and a piece of information representative of the location of the encoded data representative of the current frame in the first, transport container;
deciding to request the transmission of encoded data representative of the current frame recorded in the first, transport container according to the information obtained; and
in case of a positive decision, issuing a request message for transmitting encoded data representative of said at least one frame, comprising said location information of said encoded data in the first, transport container.

10. The device according to claim 6, wherein the device is comprises in a server equipment capable of communicating with the client equipment via the communication network.

11. The device for receiving according to claim 9, wherein the device is comprises in the client equipment, which is capable of communicating with a server equipment via the communication network.

12. A non-transitory computer-readable medium comprising instructions stored thereon, which when executed by a processor of a processing device configure the processing device to perform a method of processing encoded data representative of a sequence of digital frames, for transmission to a client equipment via a communication network in a first container, called a transport container, for storing at least the encoded data of the frames of the sequence, wherein the method comprises the following acts performed by the processing device, implemented following encoding of a current frame of said sequence:
obtaining encoded data representative of the current frame;
extracting at least one information representative of an encoding structure of the current frame;
updating the first container by inserting encoded data representative of the current frame into a predetermined location;
updating a second container, so-called metadata container, by inserting said at least one information of encoding structure and information representative of the location of the encoded data in the transport container; and
transmitting the second container to the client equipment;
upon receipt of a request from the client equipment, comprising at least one piece of information representative of the location of the data, transmitting the encoded data of the transport container corresponding to said location.

13. A non-transitory computer-readable medium comprising instructions stored thereon, which when executed by a processor of a receiving device configure the receiving device to perform a method of receiving encoded data representative of a sequence of digital frames via a communication network, wherein the method comprises the following acts, implemented by the receiving device for at least one frame of the sequence, called a current frame:
obtaining a second container, called a metadata container, comprising at least one information of an encoding structure of the current frame and a piece of information representative of the location of the encoded data representative of the current frame in a first transport container;
extracting said at least one information of an encoding structure of the current frame and a piece of information representative of the location of the encoded data representative of the current frame in a first, transport container;
deciding to request the transmission of encoded data representative of the current frame recorded in the first, transport container according to the information obtained; and
in case of a positive decision, issuing a request message for transmitting encoded data representative of said at least one frame, comprising said location information of said encoded data in the first, transport container.
